(19) United States
(12) Patent Application Publication
(10) Pub. No.: US 2026/0310625 A1
(43) Pub. Date: Oct. 8, 2026

(54) INTERRUPT STATUS SCANNING OVER MDIO/MDC INTERFACE

(71) Applicant: Microchip Technology Incorporated, Chandler, AZ (US)

(72) Inventor: Lars Ellegaard, Copenhagen S (DK)

(21) Appl. No.: 19/631,242

(22) Filed: Mar. 27, 2026

Related U.S. Application Data
(60) Provisional application No. 63/782,658, filed on Apr. 3, 2025.

(51) Int. Cl. G06F 13/42; G06F 13/24

(52) U.S. Cl. CPC G06F 13/4221; G06F 13/24

(57) ABSTRACT

An apparatus may comprise an MDIO/MDC interface, a Management Interface Input/Output (MIIM) controller, and multiple PHY devices. The Management Interface Input/Output (MIIM) controller may pause MDIO bus transactions on the MDIO line of the MDIO/MDC interface and transmit a scanning event on an MDC line of the MDIO/MDC interface. The multiple PHY devices may respond sequentially to the scanning event, a response of a respective PHY device including interrupt status information.

### CROSS-REFERENCE TO RELATED APPLICATION

This application claims the benefit under 35 U.S.C. § 119(e) of U.S. Provisional Patent Application Serial No. 63/782,658, filed Apr. 3, 2025, the disclosure of which is hereby incorporated herein in its entirety by this reference.

### FIELD

One or more examples relate, generally, to Ethernet communication systems, and more particularly, to interrupt detection and handling in Ethernet systems having multiple PHY devices communicating with a controller via an MDIO/MDC interface.

### BACKGROUND

Ethernet systems commonly include multiple Physical Layer (PHY) devices connected to a Management Interface Input/Output (MIIM) controller through a standardized Management Data Input/Output (MDIO) interface and a Management Data Clock (MDC). PHY devices typically generate interrupt signals to notify the controller or CPU of internal events requiring attention, such as timestamp availability.

### BRIEF DESCRIPTION OF THE DRAWINGS

To easily identify the discussion of any particular element or act, the most significant digit or digits in a reference number refer to the figure number in which that element is first introduced.

FIG. 1 is a schematic diagram depicting an Ethernet communication system, in accordance with one or more examples.

FIG. 2 illustrates an example process to scan interrupts across multiple PHY devices connected to an Ethernet switch via an MDIO/MDC interface, in accordance with one or more examples.

FIG. 3 illustrates a PHY-device centric process, depicting how a PHY device may respond to a scanning event initiated on an MDC line by a controller, such as a MIIM controller, in accordance with one or more examples.

FIG. 4 illustrates an example process to process and use interrupt status information received from multiple PHY devices following an interrupt scanning operation performed by a MIIM controller, in accordance with one or more examples.

FIG. 5 is a signal timing diagram depicting exemplary waveforms associated with interrupt status scanning operations involving multiple PHY devices connected via an MDIO/MDC interface, in accordance with one or more examples.

FIG. 6 is a block diagram of circuitry that, in some examples, may be used to implement various functions, operations, acts, processes, or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawing could be arranged and designed in a wide variety of different configurations. Thus, the following description of various embodiments is not intended to limit the scope of the present disclosure but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths, and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general‑purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer, including a processor is considered a special-purpose computer while the general-purpose computer executes computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, any relational term, such as “over,” “under,” “on,” “underlying,” “upper,” “lower,” without limitation, is used for clarity and convenience in understanding the disclosure and accompanying drawings and does not connote or depend on any specific preference, orientation, or order, except where the context clearly indicates otherwise.

In this description the term “coupled,” and derivatives thereof may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The term “connected” may be used in this description interchangeably with the term “coupled,” and has the same meaning unless expressly indicated otherwise or the context would indicate otherwise to a person having ordinary skill in the art.

As used herein, the terms “assert,” “de-assert” and derivatives thereof used in reference to a pin, means, respectively, to assert or de-assert a signal associated with the pin (e.g., a signal specifically assigned to the pin or a signal to which the pin is specifically assigned, without limitation).

In Ethernet systems, PHY (Physical Layer) devices commonly communicate with controllers via the IEEE 802.3-defined Management Data Input/Output (MDIO) interface, clocked by the Management Data Clock (MDC). PHY devices typically include numerous registers accessed through the MDIO interface, operating at clock frequencies ranging from approximately 2.5 MHz to 25 MHz.

A standard MDIO management frame according to IEEE 802.3 Clause 22 comprises a 32-bit preamble, a 2-bit start-of-frame delimiter, a 2-bit operation code indicating a read or write operation, a 5-bit PHY address field, a 5-bit register address field, a 2-bit turnaround, and 16 bits of data, totaling 64 bits per frame. At a typical MDC clock frequency of 2.5 MHz, each MDIO transaction requires approximately 25.6 microseconds. Accordingly, polling interrupt status registers of multiple PHY devices via sequential MDIO read transactions introduces substantial cumulative latency. For example, identifying an interrupt source among 16 PHY devices using conventional MDIO polling may require multiple read operations per PHY (e.g., three MDIO transactions per PHY for address, status register read, and data retrieval), resulting in a total identification time on the order of 1.2 milliseconds.

Certain register operations, such as retrieving timestamps from IEEE 1588 Precision Time Protocol (PTP) frames, are time-sensitive. When a PHY generates an interrupt—such as indicating the availability of a new timestamp—sometimes a main interrupt line common to multiple PHYs is asserted. To identify the interrupt source, the CPU sequentially polls each PHY’s status registers or alternatively continuously polls the PHYs periodically. This method is slow, with identification times around 1.2 milliseconds (ms) for systems with multiple PHYs (e.g., 16 PHYs), increasing CPU load and latency.

One or more examples relate, generally, to an interrupt scanning technique on the MDIO bus, which reduces the time requirement for interrupt source identification. In one or more examples, a Management Interface Input/Output (MIIM) controller functionality is expanded by adding an interrupt scanning mechanism.

Specifically, the disclosed MIIM controller pauses normal read/write transactions on the MDIO line and initiates a special (predetermined) transmit event on the MDIO Clock (MDC). Each PHY device connected to the MDIO bus recognizes this event and counts clock cycles to determine its designated response time. PHYs respond sequentially, on the MDIO bus, based on their PHY addresses, with each PHY delaying its response according to a predetermined offset:(e.g., PHY with address 00000 responds after 1 clock cycle, PHY with address 00001 responds after 1 + 4 clock cycles, PHY with address 00010 responds after 1 + 8 clock cycles, and, in general, a PHY with address N responds after 1 + (N-1)*4 clock cycles, without limitation). Each PHY response includes a leading and trailing zero to ensure smooth signal transitions between consecutive PHY responses, a transition bit set to ‘1’ to guarantee data transitions, and a bit indicating interrupt status (0 or 1).

The disclosed MIIM controller records each PHY’s interrupt status and counts responses. Upon completion of responses from all PHYs, the MIIM controller releases the collected status vector to the scanning block and resumes normal MDIO read/write transactions. This scanning operation is repeated periodically based on the expected rate of events, such as PTP timestamp generation.

The scanning technique discussed herein substantially decreases the time needed to identify the interrupt source compared to traditional techniques. For example, with 16 PHYs, traditional scanning methods take approximately 1.2 ms, while the proposed method reduces this to approximately 25 µs (61 clock cycles at 2.5 MHz MDC). Accordingly, disclosed examples may reduce the latency involved in identifying the specific PHY and interrupt source when multiple PHYs share a common interrupt line; minimize CPU load associated with periodic polling or sequential status reading across multiple PHY devices; and reduce or eliminate the necessity of a dedicated general interrupt pin, thus facilitating smaller device package sizes and reduced pin counts.

The scanning technique scales substantially linearly with the number of connected PHY devices. For N PHY devices, each providing K bits in response (e.g., K=4 for the predetermined bit format discussed herein), the total scan time is approximately 1 + (N-1) x K clock cycles. At a 2.5 MHz MDC clock frequency, a system with 32 PHY devices (the maximum number addressable under IEEE 802.3 Clause 22) may complete a scan in approximately 1 + 31 x 4 = 125 clock cycles, corresponding to approximately 50 microseconds. By contrast, conventional MDIO polling of 32 PHY devices may require on the order of 2.4 milliseconds.

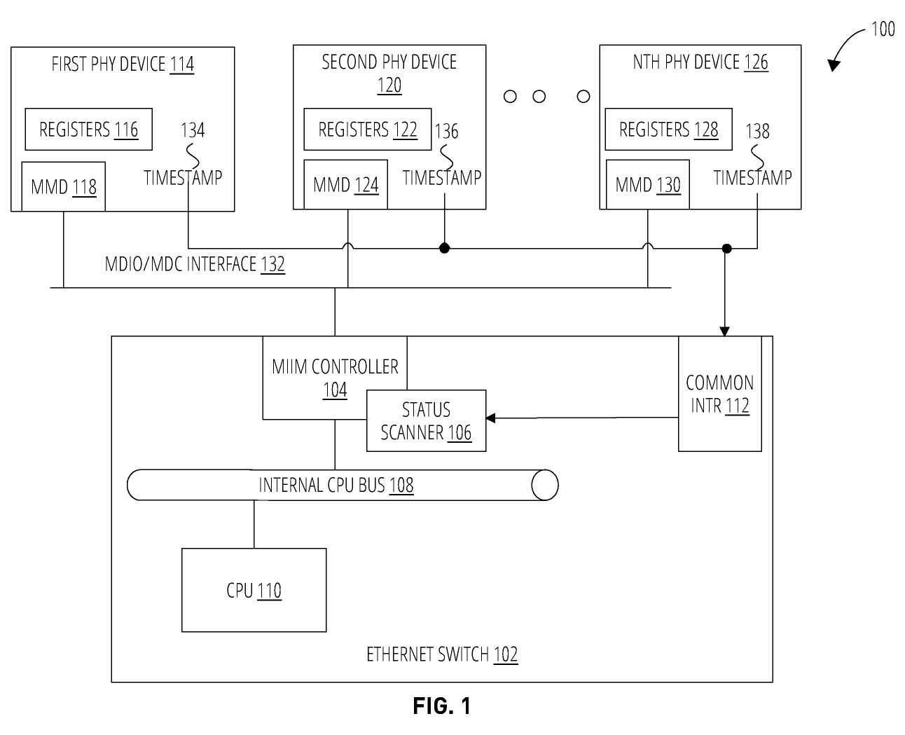

FIG. 1 is a schematic diagram depicting an Ethernet communication system 100, in accordance with one or more examples.

Ethernet communication system 100 comprises a first PHY device 114, a second PHY device 120, and up to a Nth PHY device 126, MDIO/MDC interface 132 and an Ethernet switch 102. Ethernet switch 102 includes a Management Interface Input/Output (MIIM) controller 104 (MIIM controller 104) and Central Processing Unit (CPU) 110 (CPU 110) that communicate via internal CPU bus 108.

MDIO/MDC interface 132 facilitates the communication between PHY devices (106, 108, 110) and the MIIM controller 104. MDIO/MDC interface 132 includes the Management Data Input/Output (MDIO) line for bidirectional data (e.g., control and status information, without limitation) communication and the Management Data Clock (MDC) for timing synchronization of data transfers on the MDIO line.

First PHY device 114, a second PHY device 120, and up to a Nth PHY device 126, each include internal registers 116, 122, 128, respectively, for storing data such as timestamps from IEEE 1588 Precision Time Protocol (PTP) frames, without limitation. Each PHY device further includes a Management Data Device (MMD) 118, 124, 130, respectively, to connect with the MDIO/MDC interface 132.

Each PHY device asserts interrupts based on specific internal events, such as the generation or availability of timestamps. These interrupts are communicated on a common interrupt line 112 (common INTR 112) to MIIM controller 104, which processes and identifies the interrupts as discussed, below.

Common INTR 112 conveys combined interrupt signals from one or more of the connected PHY devices to the MIIM controller 104. It consolidates multiple interrupt sources into a single interrupt line, simplifying the interrupt detection process at MIIM controller 104.

MIIM controller 104 manages and coordinates data communication and interrupt handling among PHY devices (here, first PHY device 114, second PHY device 120, and nth PHY device 126) via the MDIO/MDC interface 132, which is standardized by IEEE 802.3 for PHY device management. MIIM controller 104 includes a status scanner 106 that rapidly identifies interrupting PHY devices and their respective statuses by issuing a specialized scanning event on the MDIO/MDC interface 132, as discussed below. MIIM controller 104 communicates interrupt information (including identified interrupts and respective statuses) determined by status scanner 106 to CPU 110 via internal CPU bus 108, and CPU 110 may subsequently take appropriate actions based on the received interrupt information.

As discussed above, PHY devices 114, 120, and 126, respectively, generate interrupts in response to an internal event occurring (such as generation of a new timestamp or readiness of a timestamp to be read). In one or more examples, status scanner 106 of MIIM controller 104 may initiate a scanning event to prompt PHY devices to report their current interrupt status (whether it has already asserted an interrupt or not).

In a contemplated example interrupt scanning, the status scanner 106 temporarily pauses standard MDIO transactions on MDIO/MDC interface 132 and initiates a specific scanning event on the MDC line, effectively signaling all PHY devices connected to the MDC line (here, PHY devices 114, 120, through 126) to prepare for a rapid, coordinated response sequence. Each PHY device includes logic to detect the specific scanning event signal and, in response to detection of the scanning event, immediately begins counting MDC clock cycles from occurrence of the event. In one or more examples, each of the PHY devices determines (or already determined) a response time based on its unique PHY address. For example, the PHY device with address 00000 responds after exactly one MDC clock cycle (the response time is one MDC clock cycle), and the response time of subsequent PHY devices (based on address) are sequentially delayed by an additional predetermined number of MDC clock cycles (e.g., a two or four MDC clock cycle increment, without limitation) relative to the preceding PHY device. This allows each PHY device to respond sequentially based on its address. In one or more examples, a respective PHY device’s response is delayed relative to an immediately preceding PHY device in the sequential response by a predetermined number of clock cycles multiplied by the respective PHY device’s PHY address.

For its response, each PHY device transmits its interrupt status. In one or more examples, the interrupt status is structured in a predetermined bit format (e.g., a sequence of individual bits arranged in a particular order and structure defined, set, or chosen in advance, each bit serving a predetermined function, without limitation). For example, the predetermined bit format may include one or more of: a leading zero bit to ensure signal integrity and a smooth transition from the previous PHY device’s response; a transition bit set to ‘1’ to explicitly signal the start of valid data; a single status bit to indicate whether the PHY device asserted an interrupt (logic ‘1’) or not (logic ‘0’); and a trailing zero bit to maintain signal integrity and ensures a smooth transition to the next PHY device’s response. In this manner, interrupt status information indicates whether or not a PHY device asserted an interrupt condition.

In one or more examples, the CPU 110 constructs a prioritized servicing queue based on the contextual information received in the status vector. For example, a link-down condition may be assigned a higher servicing priority than a new timestamp event, and a counter timing event may be assigned a different priority based on the urgency of counter data retrieval. By using the contextual bits provided in the PHY responses, the CPU 110 determines a servicing order for the interrupting PHY devices without requiring additional MDIO transactions to ascertain interrupt type or severity.

In one or more examples, the response of the PHY device may optionally include additional bits with the interrupt status bits that provide contextual information. The status scanner 106 may provide some or a totality of the contextual information to the CPU 110 as discussed below. By way of non-limiting example, CPU 110 may utilize such contextual information to determine one or more of reason/type of interrupt, severity, priority among multiple interrupts based on type and/or severity and serve PHY’s based on the determined priority. As a non-limiting example, if there are 8 PHYs, two has an interrupt: one is a new timestamp, the other has link down. Then the CPU can serve the link down with higher priority than the timestamp.

In one or more examples, if a PHY device does not transmit a response at its expected time offset, the corresponding position in the status vector retains a default value (e.g., logic '0'). The status scanner 106 may identify non-responding PHY devices by detecting the absence of the expected transition bit (e.g., the '1' bit) at the expected clock cycle offset. In this manner, the MIIM controller 104 can distinguish between a PHY device that has no pending interrupt and a PHY device that failed to respond to the scanning event.

In one or more examples, the MIIM controller 104 initiates scanning operations according to one or more triggering modes. In a periodic mode, the MIIM controller 104 initiates scanning at regular intervals determined at least partially based on an expected rate of interrupt-generating events (e.g., the expected rate of PTP timestamp generation). In an event-triggered mode, the MIIM controller 104 initiates a scanning operation responsive to assertion of the common interrupt line 112 (common INTR 112). In one or more examples, the MIIM controller 104 supports both periodic and event-triggered scanning, wherein event-triggered scanning supplements periodic scanning to reduce latency when an interrupt is detected between periodic scan intervals.

As a non-limiting example, additional bits may include a link status bit to indicate if a link (e.g., associated with the respective PHY device) is lost or not lost. As a further non-limiting example, an additional bit may include a timestamp bit to indicate a presence or non-presence of a new timestamp. As a further non-limiting example, an additional bit may include a counter timing bit to indicate time or not time to read a counter value from the PHY device. The number and type of additional bits will depend on specific operating conditions.

Status scanner 106 collects each PHY’s interrupt status response sequentially and stores the received interrupt statuses in an internal vector. Due to the predetermined response order and timing based explicitly on PHY device addresses, each PHY device responds to the scanning event at a uniquely defined clock cycle offset relative to the initial event signal, dictated by its PHY address. Thus, the status scanner 106 can determine the identity of each responding PHY based on the time and/or sequential order at which each PHY’s response is received. Because the response order is fixed and predictable (based on PHY device’s addresses), the status scanner 106 can determine the position in the status vector to place each PHY’s interrupt status bit. The status scanner 106 stores the status bits at the corresponding positions within the vector, effectively encoding both the identity (address) of the PHY devices and their interrupt status. Once all PHY devices have responded or a time period for response has expired, the status scanner 106 provides the status vector to CPU 110 via the internal CPU bus 108. The CPU 110 can quickly process the received interrupt information (the information in the status vector), identifying the interrupt sources without needing additional polling or sequential register access.

In one or more examples, the CPU 110 directly interprets the interrupt status vector provided by the MIIM controller. Specifically, the interrupt status vector includes a structured set of bits, each bit corresponding uniquely to a specific PHY device. Because the order of PHY responses is predetermined based on their addresses, the CPU can immediately identify which PHY devices have asserted interrupts by simply checking the respective bits in the interrupt status vector. In cases where more than one type of event is managed by the status scanner 106, it may send event identifying information to the CPU 110 with the status vector.

In one or more examples, the scanning event is distinguishable from normal MDIO management traffic by characteristics that do not conform to the standard Clause 22 or Clause 45 framing. For example, each PHY device may include logic to monitor the MDC line for anomalies such as a pulse width exceeding a predetermined threshold, a missing clock edge within an expected clock period, or a sequence of transitions on the MDC line that does not correspond to a standard preamble and start-of-frame pattern. Upon detecting such an anomaly, the PHY device interprets the anomaly as a scanning event and initiates its response countdown based on its PHY address, as discussed herein.

The CPU 110 processes interrupt data received via internal CPU bus 108, which provides data communication paths between the CPU 110 and the MIIM controller 104. For example, after the interrupt status scanning operation is complete and the CPU identifies which PHY device or devices asserted an interrupt, the CPU can subsequently initiate specific MDIO read operations on the MDIO/MDC interface 132 to retrieve the actual timestamp data from the corresponding registers within the identified PHY devices.

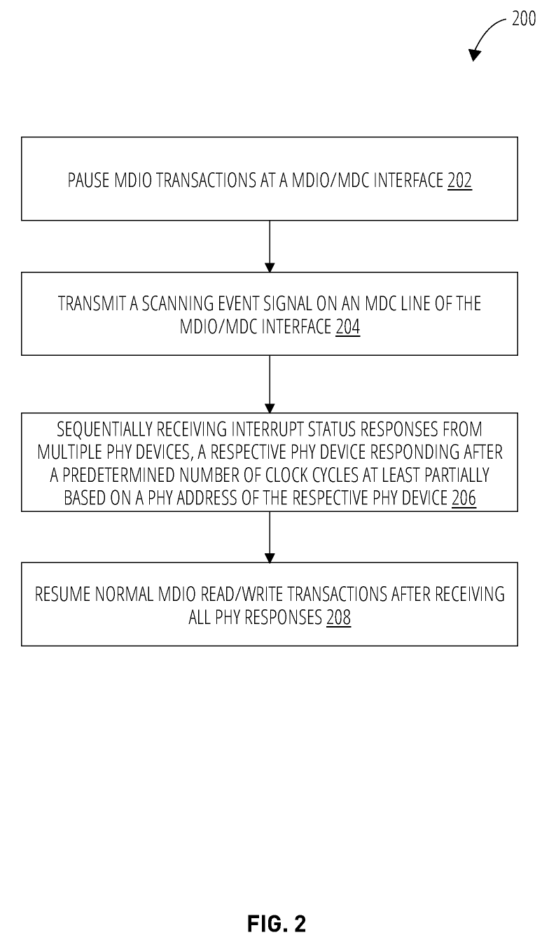

FIG. 2 illustrates an example process 200 to scan interrupts across multiple PHY devices connected to an Ethernet switch via an MDIO/MDC interface, in accordance with one or more examples. Although the example process 200 depicts a particular sequence of operations, the sequence may be altered without departing from the scope of the present disclosure. For example, some of the operations depicted may be performed in parallel or in a different sequence that does not materially affect the function of the process 200. In other examples, different components of an example device or system that implements the process 200 may perform functions at substantially the same time or in a specific sequence.

According to some examples, the method includes pausing MDIO transactions at an MDIO/MDC interface at operation 202. Pausing transactions prevents conflicts or interference between standard data transactions and a scanning operation. Pausing may be achieved by temporarily suspending ongoing read and write operations on the MDIO line.

According to some examples, the method includes transmitting a scanning event signal on an MDC line of the MDIO/MDC interface at operation 204. The scanning event effectively signals to PHY devices to sequentially report their interrupt status information. Non-limiting examples of scanning events include pulse distortion, removing one or more MDC clock pulses, or transmitting another distinctive MDC line event clearly distinguishable by all connected PHY devices.

According to some examples, the method includes sequentially receiving interrupt status responses from multiple PHY devices, a respective PHY device responding after a predetermined number of clock cycles at least partially based on a PHY address of the respective PHY device at operation 206. The sequential (in time) responses allows rapid identification of interrupting PHY devices without traditional polling delays. Each PHY device determines when to respond based on its unique PHY address, counting MDC clock cycles following the scanning event. Possible implementations include:

According to some examples, the method includes resuming normal MDIO read/write transactions after receiving all PHY responses at operation 208. Resumption of transactions on the MDIO line ensures the CPU can query the PHY devices about the interrupt status information and/or retrieve interrupt-related data from the PHY devices that reported having interrupt events.

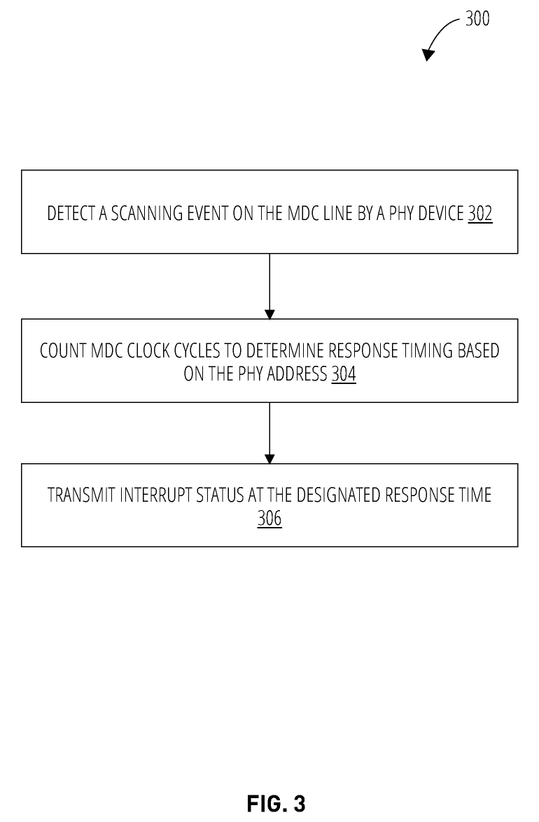

FIG. 3 illustrates a PHY-device centric process 300, depicting how a PHY device may respond to a scanning event initiated on an MDC line by a controller, such as a MIIM controller, in accordance with one or more examples. Although the example process 300 depicts a particular sequence of operations, the sequence may be altered without departing from the scope of the present disclosure. For example, some of the operations depicted may be performed in parallel or in a different sequence that does not materially affect the function of the process 300. In other examples, different components of an example device or system that implements the process 300 may perform functions at substantially the same time or in a specific sequence.

According to some examples, the method includes detecting a scanning event on the MDC line by a PHY device at operation 302. The PHY device recognize when the MIIM controller has initiated a fast interrupt scanning cycle, prompting the PHY device to prepare for sequential response transmission. In one or more examples, detection may involve monitoring for irregularities or distinctive signals, such as pulse distortion, removal of one or more MDC clock pulses, or a specialized signaling pattern on the MDC line clearly distinguishable from normal clock signaling.

According to some examples, the method includes counting MDC clock cycles to determine response timing based on the PHY address at operation 304. Counting based on its address ensures that the PHY device responds sequentially and predictably, each PHY device transmitting at a unique and predetermined time offset. This sequential response organization prevents data collision and allows for efficient and clear interrupt status collection by the MIIM controller, as discussed herein. In one or more examples, each PHY device uses its PHY address to calculate response timing. For instance, a PHY with the lowest address (e.g., address “00000”) responds after one MDC clock cycle, and each subsequent PHY responds after an additional fixed delay (e.g., four MDC clock cycles multiplied by its PHY address offset).

According to some examples, the method includes transmitting interrupt status at the designated response time at operation 306. The PHY device provides the MIIM controller with the PHY device’s current interrupt status, indicating whether an interrupt condition (e.g., availability of a timestamp) occurred. Transmission may follow a defined structured bit format, as discussed herein.

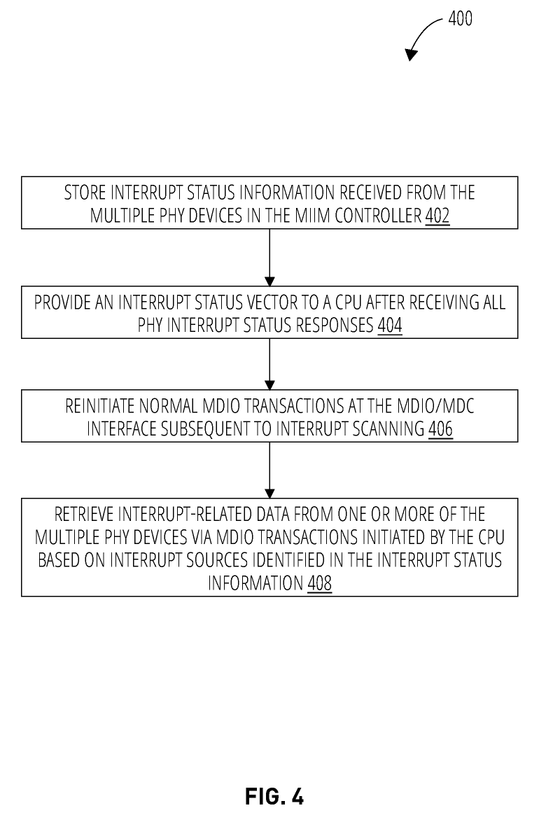

FIG. 4 illustrates an example process 400 to process and use interrupt status information received from multiple PHY devices following an interrupt scanning operation performed by a MIIM controller, in accordance with one or more examples. Although the example process 400 depicts a particular sequence of operations, the sequence may be altered without departing from the scope of the present disclosure. For example, some of the operations depicted may be performed in parallel or in a different sequence that does not materially affect the function of the process 400. In other examples, different components of an example device or system that implements the process 400 may perform functions at substantially the same time or in a specific sequence.

According to some examples, the method includes storing interrupt status information received from the multiple PHY devices in the MIIM controller at operation 402. This centralizes interrupt status information received from each PHY device into a structured form (e.g., a status vector) to enhance handling by the CPU. In one or more examples, interrupt status bits received from PHY devices are placed into predetermined positions within a status vector according to each PHY device’s address, ensuring rapid identification of interrupt sources by the CPU.

According to some examples, the method includes providing an interrupt status vector to a CPU after receiving all PHY interrupt status responses at operation 404. As discussed, the status vector consolidates interrupt information and allows for rapid and direct identification of which PHY devices had interrupt generation events. In one or more examples, providing the status vector directly to the CPU avoids additional sequential register polling or repeated MDIO transaction. In one or more examples, the interrupt status vector may be transferred to the CPU via the internal CPU bus. The CPU interprets the positions of bits within the vector to immediately identify which PHY devices have asserted interrupts.

According to some examples, the method includes reinitiating normal MDIO transactions at the MDIO/MDC interface subsequent to interrupt scanning at operation 406. Returning the MDIO/MDC interface to normal operational conditions allows for regular communication between the MIIM controller and the PHY devices via the MDIO line of the MDIO/MDC interface.

According to some examples, the method includes retrieving interrupt-related data from one or more of the multiple PHY devices via MDIO transactions initiated by the CPU based on interrupt sources identified in the interrupt status information at operation 408. Upon identifying PHY devices that asserted interrupts through analysis of the status vector, the CPU specifically requests and retrieves detailed interrupt-related information from relevant PHY devices. In one or more examples, the CPU initiates standard MDIO read transactions targeted specifically at those PHY devices identified by the status vector as having asserted interrupts. For instance, the CPU may initiate targeted MDIO read commands to retrieve timestamps or other data from the identified PHY registers.

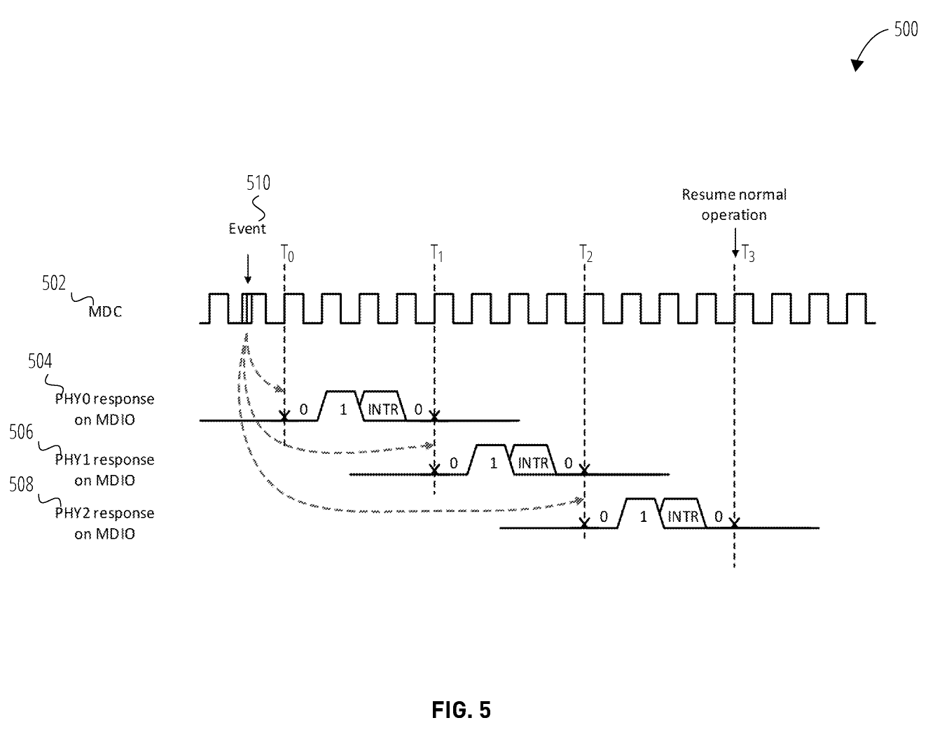

FIG. 5 is a signal timing diagram 500 depicting exemplary waveforms associated with interrupt status scanning operations involving multiple PHY devices connected via an MDIO/MDC interface, in accordance with one or more examples.

Signal timing diagram 500 shows a Management Data Clock (MDC) signal 502 on which a scanning event 510 is transmitted. The scanning event signal transmitted on the MDC line (represented at a time a couple of clock cycles before time marker T1) serves as a synchronization signal to alert connected PHY devices (PHY0, PHY1, PHY2, and potentially additional PHY devices) to prepare to respond with interrupt status information.

Upon detection of the scanning event, each PHY device begins counting MDC clock cycles to determine a specific designated response time. The PHY response timing is determined according to each PHY’s unique address, providing an organized and collision-free sequential response. As illustrated in the example:

PHY0 (response waveform 504) counts MDC clock cycles and, after a predetermined minimal delay (e.g., one MDC clock cycle), transmits its interrupt status at time marker T1. PHY1 (response waveform 506) counts an additional predetermined number of MDC cycles (for example, four additional cycles) and subsequently transmits its interrupt status at time marker T2. PHY2 (response waveform 508) similarly counts a further predetermined increment of MDC clock cycles (e.g., eight cycles from the scanning event, or four additional cycles beyond PHY1’s timing), before transmitting its interrupt status at time marker T3.

Notably, each PHY response is shown to follow a predetermined bit format structured as follows, a leading zero bit ensures proper signal integrity and clear delineation from any previous data transmission; a transition bit set to logic ‘1’ explicitly identifies the start of valid interrupt status information; an interrupt status bit (“INTR”) indicates whether the PHY device asserts an interrupt condition (logic ‘1’) or not (logic ‘0’); and a trailing zero bit follows the interrupt status bit, ensuring smooth and clear signal transition to the next PHY device response or returning the line to an idle state.

PHY devices PHY0, PHY1 and PHY2 sequentially transmit their interrupt status information at predetermined and distinct timing intervals relative to their respective PHY addresses. Specifically, PHY devices with lower PHY addresses respond earlier than devices with higher PHY addresses. The response timing of each PHY device is thus explicitly and predictably determined by its PHY address, ensuring no signal collisions and facilitating rapid identification of interrupting devices.

Following receipt of all PHY responses or upon expiration of a predetermined response period (represented at time marker T3), normal MDIO read/write transactions are resumed on the MDIO/MDC interface, returning the system to regular operational status.

As discussed above, in one or more examples, one or more additional bits may also be included in the responses of the PHY devices, to provide contextual information.

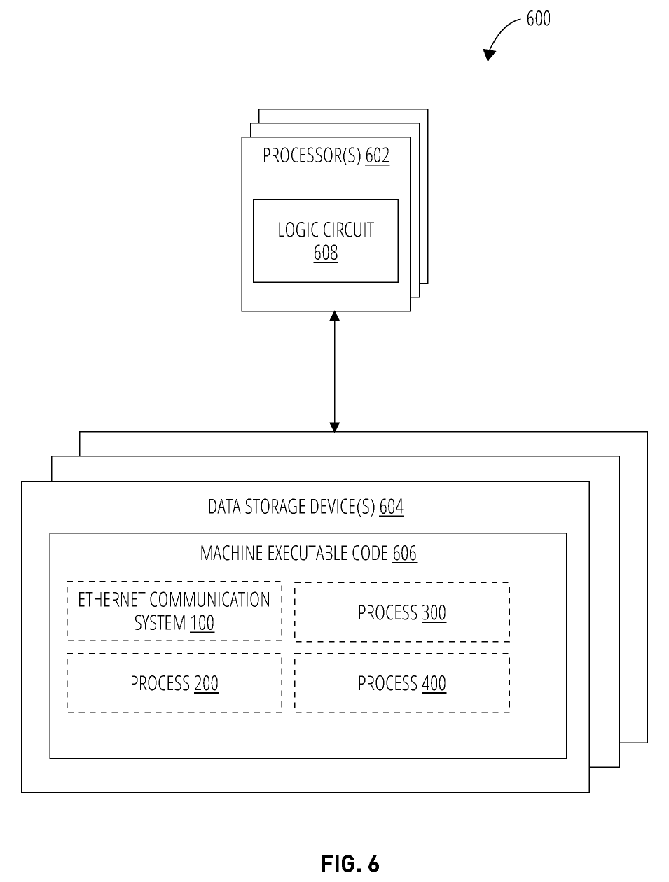

It will be appreciated by those of ordinary skill in the art that functional elements of examples disclosed herein (e.g., functions, operations, acts, processes, or methods) may be implemented in any suitable hardware, software, firmware, or combinations thereof. FIG. 6 illustrates non-limiting examples of implementations of functional elements disclosed herein. In some examples, some or all portions of the functional elements disclosed herein may be performed by hardware capable of carrying out the functional elements.

FIG. 6 is a block diagram of a circuitry 600 that, in some examples, may be used to implement various functions, operations, acts, processes, or methods disclosed herein. The circuitry 600 includes one or more processors 602 (sometimes referred to herein as “processors 602”) operably coupled to one or more data storage devices 604 (sometimes referred to herein as “storage 604”). The storage 604 includes machine executable code 606 stored thereon and the processors 602 include logic circuit 608. The machine executable code 606 includes information describing functional elements that may be implemented by (e.g., performed by) the logic circuit 608. The logic circuit 608 is adapted to implement (e.g., perform) the functional elements described by the machine executable code 606. The circuitry 600, when executing the functional elements described by the machine executable code 606, should be considered as special purpose hardware for carrying out functional elements disclosed herein. In one or more examples, the processors 602 may perform the functional elements described by the machine executable code 606 sequentially, concurrently (e.g., on one or more different hardware platforms), or in one or more parallel process streams.

When implemented by logic circuit 608 of the processors 602, the machine executable code 606 adapts the processors 602 to perform operations of examples disclosed herein. By way of non-limiting example, the machine executable code 606 may adapt the processors 602 to perform some or a totality of operations for interrupt status gathering, including of one or more of: process 200, process 300, process 400, or the processes associated with signal timing diagram 500.

Also, by way of non-limiting example, the machine executable code 606 may adapt the processors 602 to perform some or a totality of features, functions, or operations disclosed herein for one or more of: Ethernet communication system 100. More specifically, features, functions, or operations disclosed herein for one or more of: Ethernet switch 102, MIIM controller 104, status scanner 106, internal CPU bus 108, CPU 110, common INTR 112, MDIO/MDC interface 132, first PHY device 114, registers 116, MMD 118, timestamp 134, second PHY device 120, registers 122, MMD 124, timestamp 136, nth PHY device 126, registers 128, MMD 130, or timestamp 138.

The processors 602 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device (PLD), discrete gate or transistor logic, discrete hardware components, other programmable device, or any combination thereof designed to perform the functions disclosed herein. A general-purpose computer including one or more processors 602, including a general-purpose processor, is considered a special-purpose computer at least while the general-purpose computer executes functional elements corresponding to the machine executable code 606 (e.g., software code, firmware code, configuration data, hardware descriptions, without limitation) related to examples of the present disclosure. It is noted that a general-purpose processor (which may also be referred to herein as a host processor or simply a host) may be a microprocessor, but in the alternative, a general-purpose processor of processors 602 may include any conventional processor, controller, microcontroller, or state-machine. An FPGA or other PLD of the processors 602 may be configured (e.g., programmed, without limitation) with configuration data to perform functions disclosed herein, or, additionally or alternatively, may be capable of being configured or re-configured (e.g., programmable, or re-programmable, without limitation) with configuration data to perform functions disclosed herein. The processors 602 may also be implemented as a combination of computing devices, such as a combination of a DSP and a microprocessor, a plurality of microprocessors, one or more microprocessors in conjunction with a DSP core, or any other such configuration.

In one or more examples the storage 604 includes volatile data storage (e.g., random-access memory (RAM), static RAM (SRAM), without limitation), non-volatile data storage (e.g., Flash memory, a hard disc drive, a solid-state drive, erasable programmable read-only memory (EPROM), without limitation). In some examples the processors 602 and the storage 604 may be implemented into a single device (e.g., a semiconductor device product, a system on chip (SOC), without limitation). In some examples the processors 602 and the storage 604 may be implemented into separate devices.

In one or more examples the machine executable code 606 may include computer-readable instructions (e.g., software code, firmware code). By way of non-limiting example, the computer-readable instructions may be stored by the storage 604, accessed directly by the processors 602, and executed by the processors 602 using at least the logic circuit 608. Also, by way of non-limiting example, the computer-readable instructions may be stored on the storage 604, transferred to a memory device (not shown) for execution, and executed by the processors 602 using at least the logic circuit 608. Processors 602 or logic circuit 608 thereof be coupled to such a memory device or include such a memory device (e.g., a configuration memory cell, without limitation). Accordingly, in some examples the logic circuit 608 includes electrically configurable logic circuit 608.

In one or more examples the machine executable code 606 may describe hardware (e.g., circuitry) to be implemented in the logic circuit 608 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, SystemVerilog or very-large scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 608 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine executable code 606 may include an HDL, an RTL, a GL description, a mask level description, other hardware description, or any combination thereof.

In examples where the machine executable code 606 includes a hardware description (at any level of abstraction), a system (not shown, but including the storage 604) implements the hardware description described by the machine executable code 606. By way of non-limiting example, the processors 602 may include a programmable logic device (e.g., an FPGA or a PLC, without limitation) and the logic circuit 608 may be electrically controlled (e.g., via configuration data, without limitation) to implement circuitry corresponding to the hardware description into the logic circuit 608. Also, by way of non-limiting example, the logic circuit 608 may include hard-wired logic manufactured by a manufacturing system (not shown but including the storage 604) according to the hardware description of the machine executable code 606.

Regardless of whether the machine executable code 606 includes computer-readable instructions or a hardware description, the logic circuit 608 is adapted to perform the functional elements described by the machine executable code 606 when implementing the functional elements of the machine executable code 606. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the systems and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means “some or a totality.” As used herein, the term “each and every” means a “totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples include:

Example 1: An apparatus comprising: an MDIO/MDC interface; a Management Interface Input/Output (MIIM) controller to pause MDIO bus transactions on an MDIO line of the MDIO/MDC interface and transmit a scanning event on an MDC line of the MDIO/MDC interface; and multiple PHY devices to respond sequentially to the scanning event, a response of a respective PHY device including interrupt status information.

Example 2: The apparatus according to Example 1, wherein a respective response of a respective PHY device is structured according to a predetermined bit format.

Example 3: The apparatus according to any of Examples 1 and 2, wherein the respective response includes an interrupt status bit.

Example 4: The apparatus according to any of Examples 1 through 3, wherein respective ones of the multiple PHY devices to generate interrupts at least partially responsive to internal events and report their current interrupt status at least partially responsive to the scanning event.

Example 5: The apparatus according to any of Examples 1 through 4, wherein a respective current interrupt status comprises an indication of whether or not an interrupt generation event occurred.

Example 6: The apparatus according to any of Examples 1 through 5, wherein respective ones of the multiple PHY devices to respond sequentially to the scanning event at least partially based on their respective PHY address.

Example 7: The apparatus according to any of Examples 1 through 6, wherein respective ones of the multiple PHY devices transmit interrupt status after a predetermined number of clock cycles from receipt of the scanning event.

Example 8: The apparatus according to any of Examples 1 through 7, wherein respective ones of the multiple PHY devices have a respective PHY address, and wherein each PHY device to determine its response time based on its PHY address.

Example 9: The apparatus according to any of Examples 1 through 8, wherein a respective PHY device to respond at a time delayed relative to an immediately preceding PHY device in the sequential response by a predetermined number of clock cycles multiplied by the respective PHY device’s PHY address.

Example 10: The apparatus according to any of Examples 1 through 9, the MIIM controller comprising: an interrupt status vector storage within the MIIM controller, an interrupt status vector to record interrupt statuses from multiple PHY devices; and a status scanner to receive and process the interrupt status vector upon completion of a scanning cycle.

Example 11: The apparatus according to any of Examples 1 through 10, wherein the MIIM controller to collect each PHY device’s response and store interrupt status information from each PHY device in a status vector.

Example 12: The apparatus according to any of Examples 1 through 11, wherein the MIIM controller to construct the status vector by positioning each PHY device’s interrupt status information based on a sequential order determined by respective PHY device addresses.

Example 13: The apparatus according to any of Examples 1 through 12, wherein the MIIM controller to provide the status vector to a CPU after receiving responses from all PHY devices or after expiration of a predetermined response period.

Example 14: The apparatus according to any of Examples 1 through 13, wherein the CPU identifies interrupt sources directly from positions of bits in the status vector without additional MDIO transactions.

Example 15: A method comprising: pausing MDIO transactions at an MDIO/MDC interface; transmitting a scanning event signal on an MDC line of the MDIO/MDC interface; sequentially receiving interrupt status responses from multiple PHY devices, a respective PHY device responding after a predetermined number of clock cycles at least partially based on a PHY address of the respective PHY device; and resuming normal MDIO read/write transactions after receiving all PHY responses.

Example 16: The method according to Example 15, wherein each response from a PHY device includes a predetermined bit format.

Example 17: The method according to any of Examples 15 and 16, wherein the predetermined bit format comprises at least one interrupt status bit indicating whether an interrupt condition has been asserted by the PHY device.

Example 18: The method according to any of Examples 15 through 17, comprising generating interrupts within respective PHY devices in response to internal events independently of the scanning event, wherein the scanning event causes the PHY devices to report their previously generated interrupt statuses.

Example 19: The method according to any of Examples 15 through 18, wherein sequential responses from multiple PHY devices are timed based on multiplying a predetermined number of MDC clock cycles by the PHY device’s address.

Example 20: The method according to any of Examples 15 through 19, comprising storing interrupt status information from PHY devices in a status vector within a controller.

Example 21: The method according to any of Examples 15 through 20, comprising constructing the status vector by positioning each PHY device’s interrupt status information based on sequential order determined by PHY device addresses.

Example 22: The method according to any of Examples 15 through 21, comprising providing the status vector to a CPU, and wherein the CPU identifies interrupt sources directly from positions of bits within the status vector without additional MDIO transactions.

Example 23: The method according to any of Examples 15 through 22, comprising: detecting a scanning event on the MDC line by a PHY device; counting MDC clock cycles to determine response timing based on the PHY address; and transmitting interrupt status at the determined response time.

Example 24: The method according to any of Examples 15 through 23, comprising: storing interrupt status information received from the multiple PHY devices in a MIIM controller; providing an interrupt status vector to a CPU after receiving all PHY interrupt status responses; and reinitiating normal MDIO transactions at the MDIO/MDC interface subsequent to interrupt scanning.

Example 25: The method according to any of Examples 15 through 24, comprising retrieving interrupt-related data from one or more of the multiple PHY devices via MDIO transactions initiated by the CPU based on interrupt sources identified in the interrupt status information.

Example 26: The method according to any of Examples 15 through 25, wherein the scanning event comprises one or more of: a pulse distortion on the MDC line, a removal of one or more MDC clock pulses, or a predetermined pattern of transitions on the MDC line distinguishable from standard MDIO management frame signaling.

Example 27: The method according to any of Examples 15 through 26, wherein the response of the respective PHY device further includes one or more additional bits providing contextual information regarding a type of interrupt condition, the one or more additional bits including one or more of: a link status bit indicating a link condition associated with the respective PHY device, a timestamp bit indicating availability of a new timestamp, or a counter timing bit indicating a condition for reading a counter value from the respective PHY device.

Example 28: The method according to any of Examples 15 through 27, comprising prioritizing servicing of interrupting PHY devices based at least partially on the contextual information.

Example 29: The method according to any of Examples 15 through 28, initiating the scanning event signal responsive to an assertion of a common interrupt line coupled to the multiple PHY devices.

Example 30: The method according to any of Examples 15 through 28, comprising identifying a non-responding PHY device based on an absence of an expected transition bit at a clock cycle offset corresponding to the non-responding PHY device.

Example 31: The apparatus according to any of Examples 1 through 14, comprising a CPU to prioritize servicing of interrupting PHY devices based at least partially on the contextual information in the status vector.

Example 32: The apparatus according to any of Examples 1 through 14 or 31, wherein the MIIM controller to initiate the scanning event responsive to an assertion of a common interrupt line coupled to the multiple PHY devices.

Example 33: The apparatus according to any of Examples 1 through 14, 31 or 32, wherein the MIIM controller to initiate the scanning event periodically at intervals determined at least partially based on an expected rate of interrupt-generating events.

Example 34: The apparatus according to any of Examples 1 through 14 or 31 through 33, wherein the MIIM controller to identify a non-responding PHY device based on an absence of an expected transition bit at a clock cycle offset corresponding to the non-responding PHY device.

Example 35: The apparatus according to any of Examples 1 through 14 or 31 through 34, wherein the scanning event signal comprises one or more of: a pulse distortion on the MDC line, a removal of one or more MDC clock pulses, or a predetermined pattern of transitions on the MDC line distinguishable from standard MDIO management frame signaling.

Example 36: The apparatus according to any of Examples 1 through 14 or 31 through 35, wherein a respective interrupt status response further includes one or more additional bits providing contextual information regarding a type of interrupt condition, the one or more additional bits including one or more of: a link status bit, a timestamp availability bit, or a counter timing bit.

Example 37: A PHY device comprising: a management data device (MMD) coupled to an MDIO/MDC interface; detection logic to detect a scanning event on an MDC line of the MDIO/MDC interface; a counter to count MDC clock cycles subsequent to the scanning event and determine a response time based on a PHY address of the PHY device; and transmit logic to transmit interrupt status information on an MDIO line of the MDIO/MDC interface at the determined response time.

Example 38: The PHY device according to example 37, wherein the interrupt status information is structured in a predetermined bit format comprising a leading zero bit, a transition bit, an interrupt status bit, and a trailing zero bit.

Example 39: The PHY device according to either of examples 37 or 38, wherein the detection logic to detect the scanning event by identifying an anomaly on the MDC line that does not conform to standard MDIO management frame signaling.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. An apparatus comprising:
an MDIO/MDC interface;
a Management Interface Input/Output (MIIM) controller to pause MDIO bus transactions on an MDIO line of the MDIO/MDC interface and transmit a scanning event on an MDC line of the MDIO/MDC interface; and
multiple PHY devices to respond sequentially to the scanning event, a response of a respective PHY device including interrupt status information.

2. The apparatus of claim 1, wherein a respective response of a respective PHY device is structured according to a predetermined bit format.

3. The apparatus of claim 2, wherein the response includes an interrupt status bit.

4. The apparatus of claim 1, wherein respective ones of the multiple PHY devices to generate interrupts at least partially responsive to internal events and report their current interrupt status at least partially responsive to the scanning event.

5. The apparatus of claim 4, wherein the current interrupt status comprises an indication of whether or not an interrupt generation event occurred.

6. The apparatus of claim 1, wherein respective ones of the multiple PHY devices to respond sequentially to the scanning event at least partially based on their respective PHY address.

7. The apparatus of claim 1, wherein respective ones of the multiple PHY devices transmit interrupt status after a predetermined number of clock cycles from receipt of the scanning event.

8. The apparatus of claim 1, wherein respective ones of the multiple PHY devices have a respective PHY address, and wherein each PHY device to determine its response time based on its PHY address.

9. The apparatus of claim 8, wherein a respective PHY device to respond at a time-delayed relative to an immediately preceding PHY device in the sequential response by a predetermined number of clock cycles multiplied by the respective PHY device’s PHY address.

10. The apparatus of claim 1, the MIIM controller comprising:
an interrupt status vector storage within the MIIM controller, the interrupt status vector to record interrupt statuses from multiple PHY devices; and
a status scanner to receive and process the interrupt status vector upon completion of a scanning cycle.

11. The apparatus of claim 1, wherein the MIIM controller to collect each PHY device’s response and store interrupt status information from each PHY device in a status vector.

12. The apparatus of claim 11, wherein the MIIM controller to construct the status vector by positioning each PHY device’s interrupt status information based on a sequential order determined by respective PHY device addresses.

13. The apparatus of claim 11, wherein the MIIM controller to provide the status vector to a CPU after receiving responses from all PHY devices or after expiration of a predetermined response period.

14. The apparatus of claim 13, wherein the CPU identifies interrupt sources directly from positions of bits in the status vector without additional MDIO transactions.

15. A method comprising:
pausing MDIO transactions at an MDIO/MDC interface;
transmitting a scanning event signal on an MDC line of the MDIO/MDC interface;
sequentially receiving interrupt status responses from multiple PHY devices, a respective PHY device responding after a predetermined number of clock cycles at least partially based on a PHY address of the respective PHY device; and
resuming normal MDIO read/write transactions after receiving all PHY responses.

16. The method of claim 15, wherein each response from a PHY device includes a predetermined bit format.

17. The method of claim 16, wherein the predetermined bit format comprises at least one interrupt status bit indicating whether an interrupt condition has been asserted by the PHY device.

18. The method of claim 15, comprising generating interrupts within respective PHY devices in response to internal events independently of the scanning event, wherein the scanning event causes the PHY devices to report their previously generated interrupt statuses.

19. The method of claim 15, wherein sequential responses from multiple PHY devices are timed based on multiplying a predetermined number of MDC clock cycles by the PHY device’s address.

20. The method of claim 15, comprising storing interrupt status information from PHY devices in a status vector within a controller.
